(19) United States
(12) Patent Application Publication
(10) Pub. No.: US 2023/0242171 A1
(43) Pub. Date: Aug. 3, 2023

(54) STEERING WHEEL

(71) Applicant: TOYODA GOSEI CO., LTD., Kiyosu-shi (JP)

(72) Inventors: Rie ONO, Aichi-ken (JP); Tatsuya YAMADA, Aichi-ken (JP); Akitoshi NAGANAWA, Aichi-ken (JP)

(21) Appl. No.: 18/158,704

(22) Filed: Jan. 24, 2023

(30) Foreign Application Priority Data
Jan. 28, 2022 (JP) 2022-012369

(51) Int. Cl. B62D 1/04

(52) U.S. Cl. CPC B62D 1/04

(57) ABSTRACT

A steering wheel includes a grip portion to be gripped during rotation steering; a skin layer being sheet-like and disposed to cover at least an outer peripheral surface side of the grip portion; and a conductive portion using a conductive thread made of a conductive fiber and disposed on an outer surface side of the skin layer. The conductive portion includes a decorative portion formed to decorate the outer surface side of the skin layer using the conductive thread.

### CROSS-REFERENCE TO RELATED APPLICATION

This application is based on and claims priority under 35 USC 119 from Japanese Patent Application No. 2022-012369 filed on Jan. 28, 2022.

### TECHNICAL FIELD

The present disclosure relates to a steering wheel including a grip portion to be gripped at the time of rotation steering, and a sheet-like skin layer disposed so as to cover at least an outer peripheral surface side of the grip portion.

### BACKGROUND ART

In the related art, there has been a steering wheel in which a conductive portion made of a conductor is disposed in a region to come into contact with a palm, a finger, or the like of a driver during steering on an outer surface side of a grip portion to acquire biological information or the like of a driver (for example, see JP-A-2013-63214). In the steering wheel of the related art, a conductive thread is used in a sewn portion where ends of a skin layer constituting an outer peripheral surface of the grip portion are sewn to each other, and the sewn portion using the conductive thread is used as a conductive portion, and is disposed over the entire circumference of an annular ring portion as the grip portion.

However, in the steering wheel of the related art, the conductive thread is used in the sewn portion where the skin layer is sewn to form the conductive portion in the grip portion, but the conductive thread is weaker in strength than a suture thread normally used for sewing steering wheels, and is not suitable for sewing the ends of the skin layer together. Therefore, in the steering wheel of the related art manufactured by using the conductive thread, it is necessary to strengthen the structure of the portion in which the conductive thread is used separately, and there is room for improvement in terms of simple manufacturing.

### SUMMARY

The present disclosure has been made to solve the above-described problems, and an object of the present disclosure is to provide a steering wheel which can be easily manufactured even in a configuration having a conductive portion and has good design properties.

According to an aspect of the present disclosure, there is provided a steering wheel includes a grip portion to be gripped during rotation steering, a skin layer being sheet-like and disposed to cover at least an outer peripheral surface side of the grip portion, and a conductive portion using a conductive thread made of a conductive fiber and disposed on an outer surface side of the skin layer. The conductive portion includes a decorative portion formed to decorate the outer surface side of the skin layer using the conductive thread.

In the steering wheel according to the present disclosure, the conductive portion formed by using the conductive thread includes the decorative portion formed to decorate the outer surface side of the skin layer in the grip portion. In other words, the conductive thread is not used as the suture thread forming the components of the steering wheel, so that there is no problem of insufficient strength. Therefore, a common high strength suture thread can be used for manufacturing the steering wheel itself, and the steering wheel can be easily manufactured. In addition, since the conductive portion formed by using the conductive thread constitutes the decorative portion disposed on the outer surface of the skin layer, the design of the steering wheel can be improved. In the steering wheel according to the present disclosure, the conductive portion (the decorative portion) is disposed on the outer surface side of the grip portion, so that it is also possible to stably bring the conductive portion into contact with the palm, the finger, or the like of the steering operator (the driver) at the time of steering, and it is possible to stably acquire the biological information or the like of the driver.

Therefore, in the steering wheel according to the present disclosure, even the conductive portion is provided, it is still possible to easily manufacture the steering wheel, and it is possible to improve the design property.

Specifically, as the decorative portion, an oversewn portion continuously applied to the outer surface side of the skin layer across two sewn portions provided in the skin layer in the grip portion can be exemplified.

In the case where the oversewn portion is provided as the decorative portion, when the oversewn portion is divided by the left side region and the right side region of the grip portion at the time of the straight traveling steering, the oversewn portion is divided into a region gripped by the left hand of a steering operator (a driver) and a region gripped by the right hand of the steering operator (the driver), so that the electrocardiographic waveform of the steering operator (the driver) can be suitably measured as the biological information.

In addition, when the decorative portion is provided on an outer peripheral edge side which is the side away from the steering center at the time of the rotation steering in the grip portion, the decorative portion is always in contact with the palm at the time of gripping by the driver. Conversely, the decorative portion may be provided on an inner peripheral edge side which is the steering center side at the time of the rotation steering in the grip portion, and in this case, the fingertip of the thumb, the index finger, the middle finger, or the like can be brought into contact with the decorative portion at the time of gripping by the driver.

Furthermore, if the decorative portion includes an embroidery portion formed in the grip portion or a region in the vicinity of the grip portion, such an embroidery portion can also be used as a switch or a touch sensor. Further, by providing the embroidery portion, the design of the steering wheel can be further improved.

In addition, the conductive portion using the conductive thread may be disposed on a back surface side of the grip portion as long as the conductive portion is sewn so as not to require strength.

### BRIEF DESCRIPTION OF DRAWINGS

FIG. 1 is a plan view of a steering wheel according to an embodiment of the present disclosure.

FIG. 2 is a partially cutaway perspective view schematically illustrating a portion of a ring portion as a grip portion in the steering wheel illustrated in FIG. 1.

FIG. 3 is a schematic sectional view of a portion of the ring portion in the steering wheel illustrated in FIG. 1.

FIG. 4 is a partially enlarged view illustrated in FIG. 3.

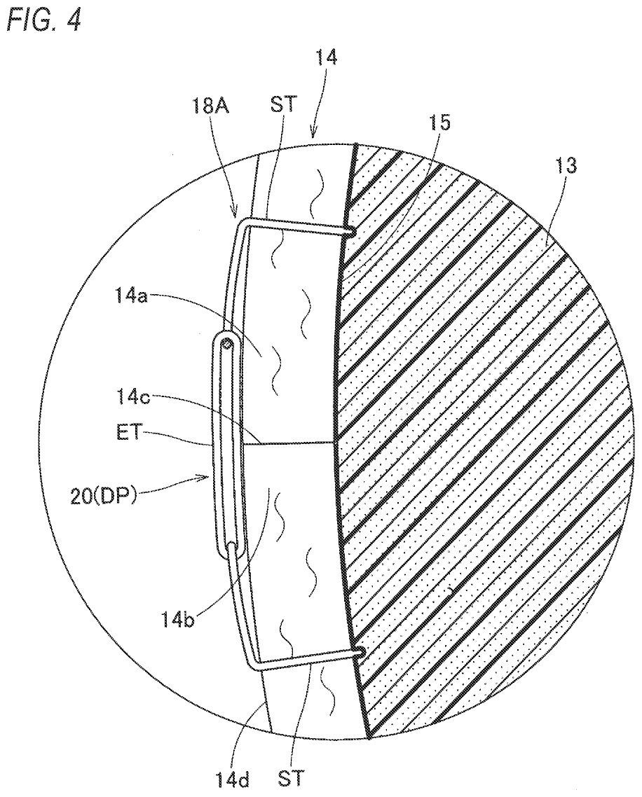

FIGS. 5A and 5B are schematic views of the ring portion in the steering wheel illustrated in FIG. 1, as viewed from an inner peripheral side, illustrating a state before and after an oversewn portion is formed.

FIG. 6 is a schematic view of a front region of the ring portion in the steering wheel illustrated in FIG. 1 as viewed from the inner peripheral side.

FIG. 7 is a schematic side view of a steering wheel according to another embodiment of the present disclosure.

FIG. 8 is a partially enlarged plan view of a steering wheel according to still another embodiment of the present disclosure.

FIG. 9 is a schematic sectional view of a portion of a ring portion in a steering wheel according to still another embodiment of the present disclosure.

### DESCRIPTION OF EMBODIMENTS

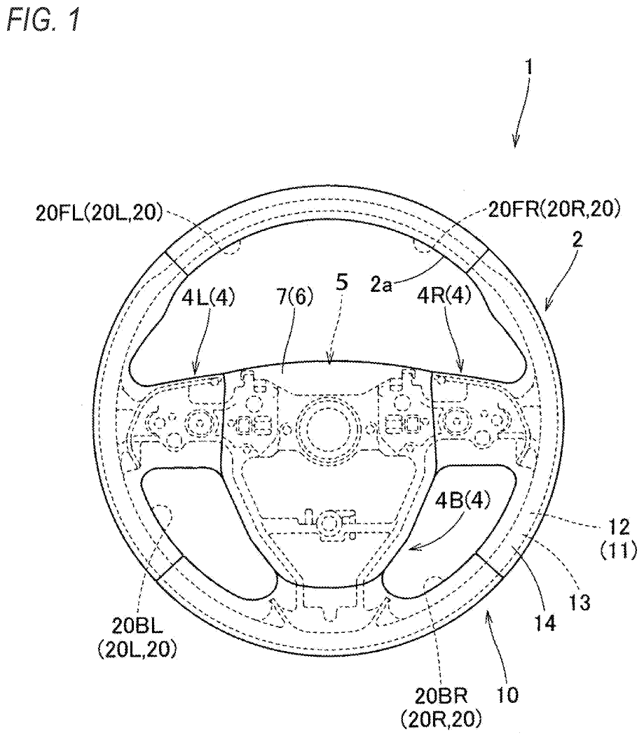

Hereinafter, embodiments of the present disclosure will be described with reference to the drawings. As illustrated in FIG. 1, a steering wheel 1 according to the embodiment includes an annular ring portion 2 which is gripped during rotation steering, a boss portion 5 which is disposed substantially at the center of the ring portion 2, and a plurality of (three in the embodiment) spoke portions 4 which connect the ring portion 2 and the boss portion 5. In the steering wheel 1 according to the embodiment, the ring portion 2 constitutes a grip portion. The steering wheel 1 includes, as components, an airbag device 6 above the boss portion 5 and a steering wheel main body 10 other than the airbag device 6.

In the present description, unless otherwise specified, a front-rear direction, an upper-lower direction, and a left-right direction are defined based on a straight traveling steering state of the steering wheel 1 mounted on a vehicle, such that a direction along a rotation center axis of the ring portion 2 is defined as the upper-lower direction, a direction perpendicular to the rotation center axis of the ring portion 2 and substantially along a front-rear direction of the vehicle is defined as the front-rear direction, and a direction perpendicular to the rotation center axis of the ring portion 2 and substantially along a left-right direction of the vehicle is defined as the left-right direction.

The airbag device 6 disposed above the boss portion 5 includes an airbag (not illustrated) which is folded and housed, an inflator (not illustrated) which supplies inflation gas to the airbag, and a pad 7 which covers an upper surface side of the folded airbag. As illustrated in FIG. 1, the pad 7 is disposed so as to cover an entire upper surface side of the boss portion 5.

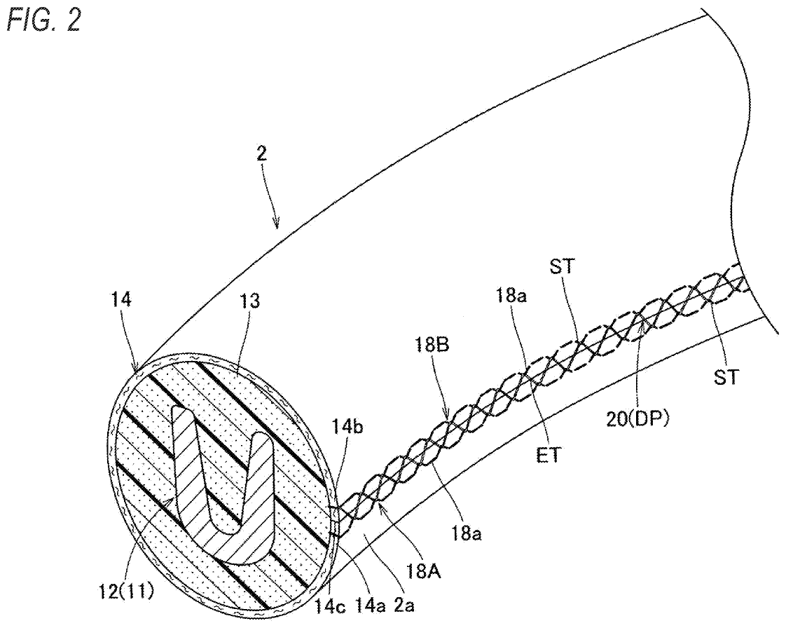

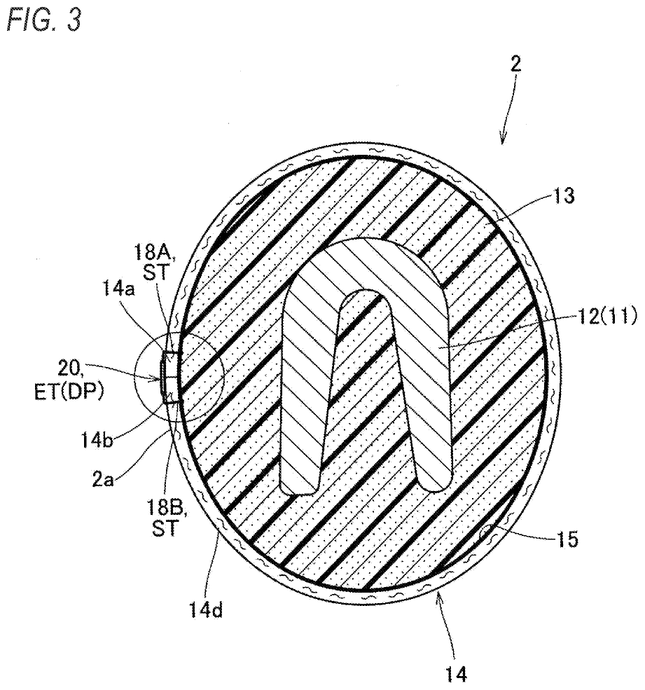

As illustrated in FIGS. 1 to 3, the steering wheel main body 10 includes a core metal 11 disposed so as to connect the ring portion 2, the boss portion 5, and the spoke portions 4 to each other, a covering layer 13 covering a periphery of the core metal 11 at portions of the ring portion 2 and the spoke portion 4, a skin layer 14 covering an outer peripheral surface side of the covering layer 13, and a lower cover (not illustrated) covering a lower surface side of the boss portion 5. In the steering wheel 1 according to the embodiment, a decorative portion DP (conductive portion) is disposed on an outer surface 14d side of the skin layer 14 of the steering wheel main body 10 (see FIGS. 2 and 3). The ring portion 2 as the grip portion has a substantially circular shape in cross section (specifically, a substantially elliptical shape in cross section), and includes a ring portion core metal 12 disposed on the center side, the covering layer 13 covering the periphery of the ring portion core metal 12, and the skin layer 14 covering the outer peripheral surface side of the covering layer 13 (that is, an outer peripheral surface side of the ring portion 2).

The core metal 11 is made of a metal such as an aluminum alloy. In the core metal 11, a ring portion core metal 12 disposed at the part of the ring portion 2 has a substantially inverted U-shape in a cross section (see FIGS. 2 and 3).

The covering layer 13 is formed of a soft synthetic resin having cushioning properties, and in the embodiment, the covering layer 13 is formed of a soft foamed material such as foamed polyurethane. The covering layer 13 is configured to cover an outer peripheral side of the ring portion metal core 12 at the part of the ring portion 2, and has a substantially elliptical cross-sectional shape.

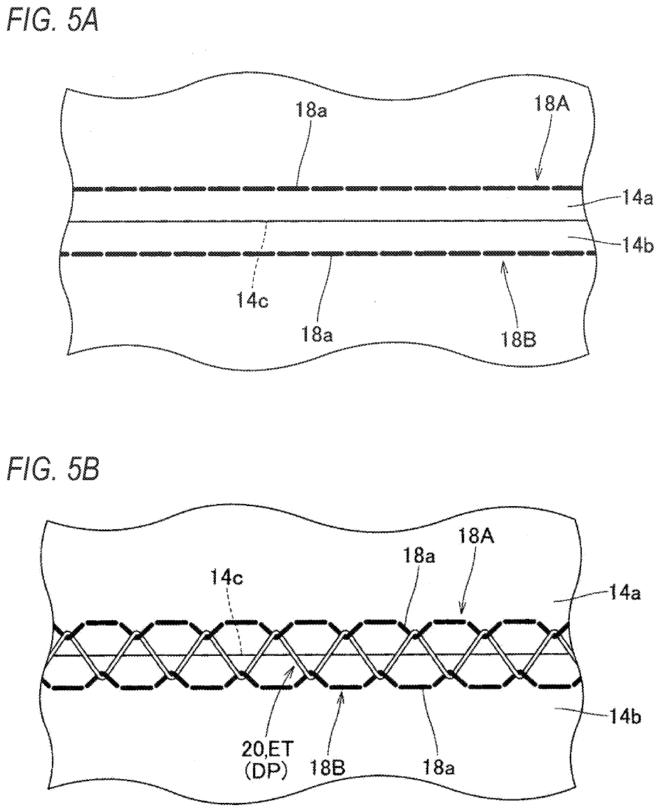

The skin layer 14 is disposed so as to cover the outer peripheral surface side of the covering layer 13, and in the embodiment, is formed of leather such as natural leather, synthetic leather, or artificial leather. In the steering wheel 1 according to the embodiment, the skin layer 14 is disposed to cover the outer surface side of the ring portion 2 such that the ends 14a and 14b are in contact with each other on an inner peripheral edge 2a side which is the steering center side (the boss portion 5 side) during the rotation steering (see FIGS. 2 and 3). Specifically, the ends 14a and 14b of the skin layer 14 are in contact with each other so that end surfaces are brought into contact with each other at a substantially central position in the upper-lower direction on the inner peripheral edge 2a side of the ring portion 2. In the embodiment, the skin layer 14 is adhered to the covering layer 13 via an adhesive layer 15 formed on an inner surface side, and sewn portions 18A and 18B are continuously formed over the entire length of the skin layer 14 so as to be substantially along the end surface by using a suture thread ST for end processing at portions in the vicinity of the ends 14a and 14b of the skin layer 14. Specifically, the skin layer 14 is attached to the covering layer 13 via the adhesive layer 15 so as to cover the outer peripheral surface side of the covering layer 13 substantially without a gap, in such a manner that contact surfaces 14c with which the end surfaces of the terminals 14a and 14b are brought into contact are disposed substantially along the circumferential direction (ring surface) of the ring portion 2 at the substantially center in the upper-lower direction of the ring portion 2, and the two sewn portions 18A and 18B disposed on the respective ends 14a and 14b are formed substantially parallel to the contact surfaces 14c (respective end surfaces) (see FIG. 5A) over the entire length of the skin layer 14. In the steering wheel 1 according to the embodiment, four skin layers 14 are provided so as to cover regions obtained by dividing the ring portion 2 into four substantially in the front-rear and left-right directions.

In the steering wheel 1 according to the embodiment, the oversewn portion 20 serving as the decorative portion DP is formed across the two sewn portions 18A and 18B described above. The oversewn portion 20 is continuously formed by hooking a threads (a conductive thread ET in the embodiment) on seams 18a constituting the sewn portions 18A and 18B to connect the sewn portions 18A and 18B and form a zigzag shape so as to be inclined with respect to the sewn portions 18A and 18B (see FIG. 2 and FIG. 5B). In the embodiment, the oversewn portion 20 is continuously formed over substantially the entire length of the sewn portions 18A and 18B (substantially the entire length of the contact surface 14c with which the end surfaces of the ends 14a and 14b of the skin layer 14 are in contact) on the outer surface 14d side of the skin layer 14. The oversewn portion 20 is formed by using the conductive thread ET made of a conductive fiber, and constitutes the conductive portion. The oversewn portion 20 is formed of the conductive thread ET and constitutes the conductive portion so as to acquire biological information or the like of the driver. In the embodiment, specifically, the oversewn portion 20 is used as a contact type electrocardiogram sensor capable of measuring an electrocardiographic waveform of a driver (not illustrated) by bringing a finger of a steering operator (the driver) into contact with the oversewn portion 20 when the oversewn portion 20 is gripped. In the embodiment, the oversewn portion 20 is formed over substantially the entire length of the sewn portions 18A and 18B, that is, over substantially the entire region on the inner peripheral edge 2a side of the ring portion 2 including the edge portion of each spoke portion 4 (see FIG. 1).

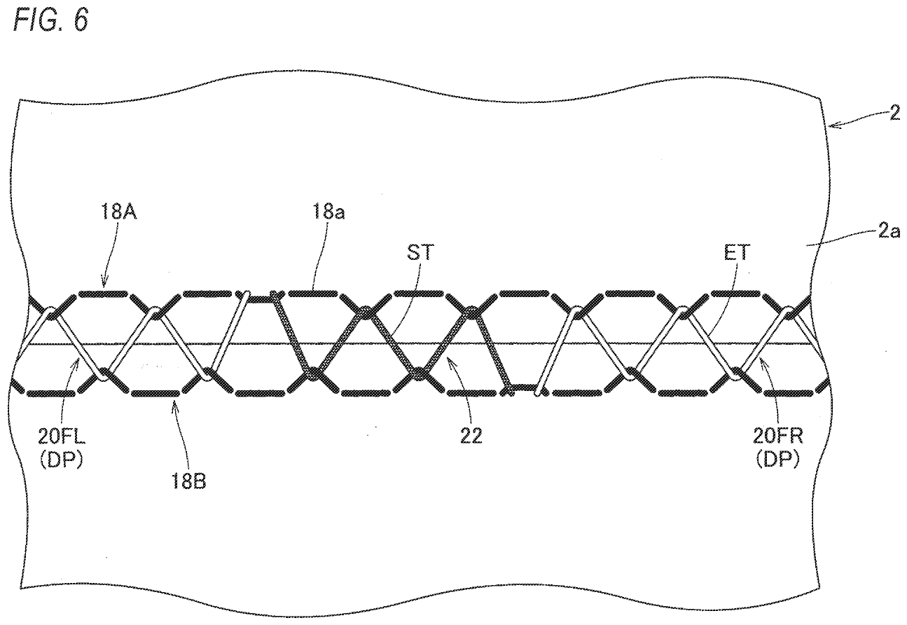

Further, in the embodiment, the oversewn portion 20 is divided into a left side region and a right side region of the ring portion 2 at the time of straight traveling steering, and has a left side portion 20L and a right side portion 20R. Specifically, since the steering wheel 1 according to the embodiment includes the three spoke portions 4L, 4R, and 4B, the region of the ring portion 2 on the inner peripheral edge 2a side is divided into three by the three spoke portions 4L, 4R, and 4B. That is, the oversewn portion 20 includes a portion (front left portion 20FL, front right portion 20FR) disposed in a front region between the spoke portions 4L and 4R, a portion (rear left portion 20BL) disposed in a rear left region between the spoke portions 4L and 4B, and a portion (rear right portion 20BR) disposed in a rear right region between the spoke portions 4R and 4B. In the oversewn portion 20, the portion disposed in the front region between the spoke portions 4L and 4R is divided into the front left portion 20FL and the front right portion 20FR on the left and right sides by interposing therebetween a general portion 22 formed of a general suture thread ST which is a non-conductive material (see FIG. 6). In the oversewn portion 20 of the embodiment, the front left portion 20FL and the rear left portion 20BL constitute the left side portion 20L, and the front right portion 20FR and the rear right portion 20BR constitute the right side portion 20R. The left side portion 20L (the front left portion 20FL and the rear left portion 20BL) is disposed in a region gripped mainly by the left hand of the steering operator (the driver) during steering, and the right side portion 20R (the front right portion 20FR and the rear right portion 20BR) is disposed in a region gripped mainly by the right hand of the steering operator (the driver). Although detailed illustration is omitted, each conductive thread ET constituting the front left portion 20FL, the rear left portion 20BL, the front right portion 20FR, and the rear right portion 20BR is disposed to pass through a recessed groove formed in the covering layer 13 on the back surface side of the skin layer 14, and is electrically connected to a control circuit (not illustrated) through the recessed groove.

In the steering wheel 1 according to the embodiment, the conductive portion formed by using the conductive thread ET includes the decorative portion DP (in the embodiment, the oversewn portion 20) formed to decorate the outer surface side of the skin layer 14 in the ring portion 2 as the grip portion. In other words, the conductive thread is not used as the suture thread forming the components of the steering wheel, so that there is no problem of insufficient strength. Therefore, a common high strength suture thread can be used for manufacturing the steering wheel 1 itself, and the steering wheel 1 can be easily manufactured. In addition, since the conductive portion formed by using the conductive thread ET constitutes the decorative portion DP (the oversewn portion 20) disposed on the outer surface of the skin layer 14, the design of the steering wheel 1 can be improved. In the steering wheel 1 according to the embodiment, the conductive portion (the decorative portion DP, the oversewn portion 20) is disposed on the outer surface side of the ring portion 2 as the grip portion, so that it is also possible to stably bring the conductive portion into contact with the palm, the finger, or the like of the steering operator (the driver) at the time of steering, and it is possible to stably acquire the biological information (in the case of the embodiment, the electrocardiographic waveform) or the like of the driver.

Therefore, in the steering wheel 1 according to the embodiment, even the conductive portion is provided, it is still possible to easily manufacture the steering wheel 1, and it is possible to improve the design property.

Further, in the steering wheel 1 according to the embodiment, the oversewn portion 20 serving as the decorative portion DP is divided by the left side region and the right side region of the ring portion 2 at the time of the straight traveling steering, that is, the oversewn portion 20 is divided into the left side portion 20L disposed in the region gripped by the left hand of the steering operator (the driver) and the right side portion 20R disposed in the region gripped by the right hand of the steering operator (the driver), so that the electrocardiographic waveform of the steering operator (the driver) can be suitably measured as the biological information.

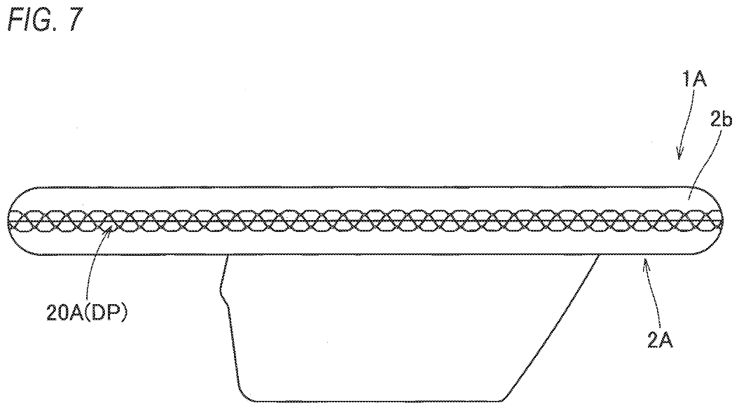

Further, in the steering wheel 1 according to the embodiment, since the oversewn portion 20 as the decorative portion DP is provided on the inner peripheral edge 2a side which is the steering center side (the boss portion 5 side) at the time of the rotation steering in the ring portion 2, the fingertip of the thumb, the index finger, the middle finger, or the like can be brought into contact with the oversewn portion 20 when the driver (the steering operator) grips the ring portion 2. As in a steering wheel 1A illustrated in FIG. 7, an oversewn portion 20A as the decorative portion DP may be provided on an outer peripheral edge 2b side of a ring portion 2A, which is the side away from the steering center during the rotation steering (the side away from the boss portion 5). In the steering wheel 1A, although a detailed description is omitted, the oversewn portion 20A is also divided into two on the left and right sides. With such a configuration, when the ring portion 2A is gripped by the driver, the palm can always be brought into contact with the oversewn portion 20A (conductive portion), and a contact state can be stabilized as compared with a case where the oversewn portion 20A is provided on the inner peripheral edge side, and the biological information and the like of the driver can be acquired more stably.

The steering wheel 1, 1A according to the embodiment is configured to acquire the electrocardiographic waveform of the driver who grips the ring portion 2, 2A by using the oversewn portion 20, 20A (decorative portion DP, conductive portion) as a contact type electrocardiogram sensor. Alternatively, the oversewn portion may be used as a touch sensor for detecting a gripped state of the ring portion by the driver (steering operator). When used as a touch sensor, the oversewn portion may not be divided into two on the left and right sides. Note that, in the embodiment, the oversewn portion 20 is formed across the two sewn portions 18A and 18B provided for the end processing in the vicinity of the ends 14a and 14b of the skin layer 14, respectively. Alternatively, the sewn portions for providing the oversewn portion is not limited to the one provided for the end processing of the skin layer, and two sewn portions may be provided at any position in the ring portion.

Further, in the steering wheel 1, 1A according to the embodiment, the oversewn portion 20, 20A formed of the conductive thread ET is disposed over substantially the entire circumference of the ring portion 2, 2A. Alternatively, the oversewn portion formed of the conductive thread may be partially provided only in a region which is mainly gripped during steering (for example, in the skin layer divided into four, only the regions of the skin layer disposed on the left side and the right side). In a case of such a configuration, when the remaining region is provided with an oversewn portion formed of a general suture thread which is not a conductive thread, decoration by oversewing is applied over substantially the entire length of the sewn portion (substantially the entire circumference of the ring portion) in appearance, and the design is improved.

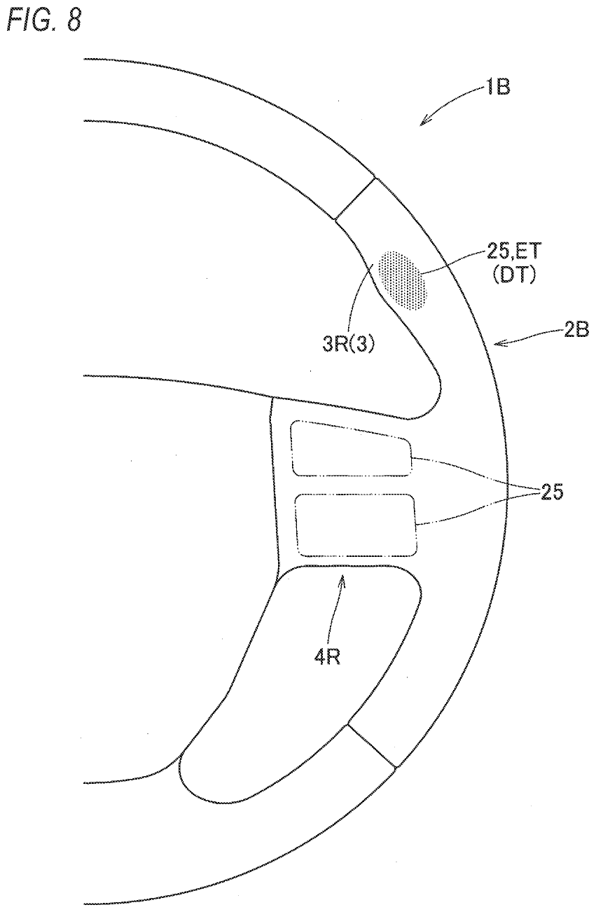

Furthermore, as the decorative portion DP formed on the outer surface of the skin layer using the conductive thread ET, an embroidery portion 25 disposed on the outer surface side of left and right finger rest portions 3 (3R) (specifically, on an upper surface side of the finger rest portion 3R) in a ring portion 2B, as in a steering wheel 1B illustrated in FIG. 8, can also be exemplified. In FIG. 8, only a right half region of the steering wheel 1B is illustrated, and a left half region is not illustrated, and the left finger rest portion is also formed with the embroidery portion. In the embodiment, an outer shape of the embroidery portion 25 is a substantially elliptical shape, and the embroidery portion 25 is formed so as to cover substantially the entire surface of an outer surface 14d side of a skin layer 14B in the elliptical region with the conductive thread ET. Similarly to the conductive thread constituting the oversewn portion in the steering wheel described above, the conductive thread ET constituting the embroidery portion 25 is electrically connected to a control circuit (not illustrated) through a recessed groove formed in a covering layer (not illustrated) on the back surface side of the skin layer. The embroidery portion 25 can be brought into contact with the thumb of a driver D gripping the ring portion 2B, and can be used as a contact type electrocardiogram sensor or a touch sensor as in the case of the steering wheel 1, 1A described above, and can also be used as a switch for operating the device. In addition, such an embroidery portion may be disposed not only in the ring portion but also in a region of a spoke portion 4R in the vicinity of the ring portion 2B (a region in which the skin layer is disposed so as to be continuous from the ring portion on the front surface side) (refer to a two-dot chain line in FIG. 8). When the embroidery portion is disposed at such a position, the embroidery portion can be suitably used as a switch for operating the device. By forming the embroidery portion, for example, it is possible to dispose the embroidery having various designs such as an emblem of the vehicle and a geometric pattern on the outer surface side of the steering wheel, and it is possible to further improve the design of the steering wheel. The embroidery portion 25 as such a conductive portion is formed so as to cover the outer surface side of the skin layer 14B by using the conductive thread ET made of a conductive fiber, so that it is easily to follow the outer surface of the ring portion 2B, and as compared with a switch or an energization sensor normally used in a steering wheel, for example, it is not necessary to provide a recessed portion for installation in the covering layer, and therefore, there is no need to change the design of the steering wheel. Therefore, it is also possible to mount the conductor simply and inexpensively. Further, as compared with a case where the conductive portion is formed using a sheet-like conductor, the conductive portion formed of the embroidery portion using the conductive thread has a large surface area and can ensure a large contact area with the skin of the driver.

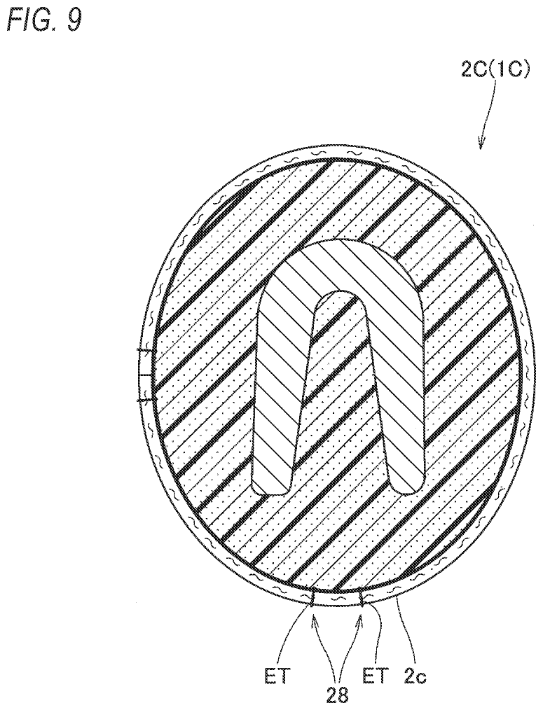

Further, as illustrated in FIG. 9, a steering wheel 1C may have a configuration in which a conductive portion using the conductive thread ET is disposed on a back surface 2c side of a ring portion 2C. In the steering wheel 1C, in addition to a sewn portion disposed on an end side of a skin layer 14C which covers the outer surface side of the ring portion 2C, sewn portions 28A and 28B which are simply disposed so as to sew the skin layer 14C are continuously formed in a double line shape using the conductive thread ET to constitute the conductive portion. That is, the sewn portions 28A and 28B are sewn so as not to require strength. When the ring portion is gripped by the driver, the sewn portions 28A and 28B come into contact with the vicinity of the intermediate portion of the four fingers excluding the thumb of the hand of the driver. As described above, when the continuous sewn portions 28A and 28B are provided on the back surface 2c side of the ring portion 2C as the conductive portion, the sewn portions 28A and 28B can also be used as a contact type electrocardiogram sensor or a touch sensor, similarly to the steering wheel 1, 1A described above.

The steering wheel 1, 1A, 1B, or 1C according to the embodiment includes the annular ring portion 2, 2A, 2B, or 2C as the grip portion, but the steering wheel to which the present invention can be applied is not limited to the configuration including an annular ring portion. For example, the present invention can also be applied to a steering wheel including a square annular ring portion as the grip portion, or a steering wheel including a rod-shaped grip portion which partially protrudes from the boss portion instead of the ring portion.

What is claimed is:

1. A steering wheel comprising:
a grip portion to be gripped during rotation steering;
a skin layer being sheet-like and disposed to cover at least an outer peripheral surface side of the grip portion; and
a conductive portion using a conductive thread made of a conductive fiber and disposed on an outer surface side of the skin layer,
wherein the conductive portion includes a decorative portion formed to decorate the outer surface side of the skin layer using the conductive thread.

2. The steering wheel according to claim 1,
wherein the decorative portion includes an oversewn portion continuously applied to the outer surface side of the skin layer across two sewn portions provided in the skin layer in the grip portion.

3. The steering wheel according to claim 2,
wherein the oversewn portion is divided into a left region and a right region of the grip portion at a time of straight traveling steering.

4. The steering wheel according to claim 1,
wherein the decorative portion is disposed on an outer peripheral edge side of the grip portion, the outer peripheral edge side being a side away from a steering center during rotation steering.

5. The steering wheel according to claim 1,
wherein the decorative portion is disposed on an inner peripheral edge side of the grip portion, the inner peripheral edge side being a steering center side during rotation steering.

6. The steering wheel according to claim 1,
wherein the decorative portion includes an embroidery portion formed in the grip portion or a region in the vicinity of the grip portion.

7. A steering wheel comprising:
a grip portion to be gripped during rotation steering;
a skin layer being sheet-like and disposed to cover at least an outer peripheral surface side of the grip portion; and
a conductive portion using a conductive thread made of a conductive fiber and disposed on an outer surface side of the skin layer,
wherein the conductive portion is disposed on a back surface side of the grip portion.
